(19) United States
(12) Patent Application Publication
(10) Pub. No.: US 2026/0142396 A1
(43) Pub. Date: May 21, 2026

(54) RUGGED, HIGH VOLTAGE, LOW CURRENT CONNECTOR

(71) Applicant: FCI Nantong Ltd., Nantong (CN)

(72) Inventors: Koen Maddens, Hofstade (BE); Luokui Zhang, Nantong (CN); Dandan Wu, Nantong (CN)

(73) Assignee: FCI Nantong Ltd., Nantong (CN)

(21) Appl. No.: 19/119,739

(22) PCT Filed: Oct. 10, 2022
(86) PCT No.: PCT/CN2022/124369

§ 371 Date: Apr. 9, 2025

(51) Int. Cl. H01R 12/79; H01R 12/58; H01R 13/422; H01R 13/436; H01R 13/502; H01R 13/506; H01R 13/533; H01R 43/20

(52) U.S. Cl. CPC H01R 12/79; H01R 12/585; H01R 13/4223; H01R 13/4364; H01R 13/5025; H01R 13/506; H01R 13/533; H01R 43/20; H01R 2201/26

(57) ABSTRACT

An interconnection system for making high voltage connections in harsh environments in which the connector may be subjected to vibrations, such as in a vehicle. A cable connector may have a TPA that can be inserted into the connector housing without openings in a sidewall, which facilitates long creepage paths. A board connector may have fins with portions extending in multiple directions at the mounting interface. Such connectors may be designed with structures that may be lengthened or shortened to establish desired creepage and clearance distances without changing the connector pitch, which may yield economies for designers of systems that use such connectors. Further, such fins, in addition to providing a long creepage path, enable flexible use the same connector housing, such as enabling it to receive terminals that support different mounting technologies for mounting the housing in different orientations.

### FIELD OF THE DISCLOSURE

The technology disclosed herein relates to electrical interconnection systems, such as connectors for supplying electrical power in harsh environments.

### BACKGROUND

This patent application relates generally to interconnection systems, such as those including electrical connectors, used to interconnect electronic assemblies, and more specifically to interconnection systems for making high voltage connections in harsh environments in which the connector may be subjected to vibrations, such as in a vehicle.

Electrical connectors are used in many electronic systems. It is generally easier and more cost effective to manufacture a system as separate electronic assemblies, which may be joined together with electrical connectors. Connectors may be used for interconnecting assemblies so that the assemblies may operate together as part of a system. Connectors, for example, may be mounted on printed circuit boards within two assemblies that are connected by mating the connectors. In other systems, it may be impractical to join two printed circuit boards by directly mating connectors on those printed circuit boards. For example, when the system is assembled, those printed circuit boards may be separated by too great a distance for a direct connection between connectors mounted on the printed circuit boards.

In some systems, connections between assemblies may be made through cables. The cables may be terminated with connectors that mate with connectors mounted on a printed circuit board. In this way, connections between assemblies may be made by plugging a connector that is part of a cable assembly into a connector that is mounted on a printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine, transmission (TCUs), security system, emissions control, lighting, advanced driver assistance system (ADAS), entertainment system, navigation system, and cameras. The ECUs may be manufactured as separate assemblies and connected over one or more vehicle networks formed with cables routed between these assemblies. To simplify manufacture of an automobile, the assemblies may be formed separately and then connected via cables that are terminated with connectors that enable connections to mating connectors terminating other cables or attached to printed circuit boards within the assemblies.

An automobile presents a harsh environment for an electrical connector. The automobile may vibrate, which can cause a connector to unmate and cease working entirely. Alternatively, vibrations may loosen terminals within the connector, which can similarly disrupt operation of the connector. Accordingly, some connectors intended for use in harsh environments include a Terminal Position Assurance device (TPA).

Connectors that carry high voltages may be designed with a creepage distance that precludes arcing in the intended operating environment for the connector.

Creepage distance is the path length along surfaces between two conductors across which the high voltage may exist in operation. The connector may also be designed with a clearance distance that precludes arcing. Clearance may be based on a shortest path through air between two conductors across which the high voltage may exist in operation. The creepage and clearance distance that precludes arcing may depend on factors, such as the magnitude of the voltage across adjacent conductors in the connector and degree of contamination in the operating environment.

### SUMMARY

Concepts as described herein may be embodied as an electrical connector, comprising an insulative housing comprising a plurality of pillars, each pillar of the plurality of pillars comprising a channel extending parallel to a mating direction; a plurality of terminals, each of the plurality of terminals comprising a mating contact portion disposed within a respective channel of a pillar of the plurality of pillars; and a terminal position assurance device (TPA) comprising a body and a plurality of projections extending from the body, each of the plurality of projections extending into the channel of a respective pillar of the plurality of pillars, wherein: each of the plurality of projections comprises a latching feature and each of the plurality of terminals comprises a complementary latching feature configured to engage with the latching feature of a projection of the plurality of projections; and the TPA is configured to slide parallel to the mating direction into the insulative housing such that the latching features of the TPA engage the complementary latching features of the terminals within the channels of the plurality of pillars.

In another aspect, a connector may comprise: an insulative housing comprising a plurality of pillars, each of the plurality of pillars comprising a channel extending in a mating direction; and a terminal position assurance device (TPA) comprising a body and a plurality of projections extending from the body, each of the plurality of projections aligned with the channel of a respective pillar of the plurality of pillars and comprising a latching feature, wherein the TPA is configured to slide in a direction opposite the mating direction into the insulative housing.

In yet another aspect, a method of assembling an electrical connector comprising an insulative housing with a plurality of channels and a terminal position assurance device (TPA) comprising a plurality of projections with a latching feature associated with each of the plurality of projections, may comprise: with the TPA partially inserted into the insulative housing of the electrical connector with each of the plurality of projections aligned with a respective channel of the insulative housing of the electrical connector, inserting a plurality of terminals comprising complementary latching features into the TPA such that the complementary latching feature of each of the plurality of terminals engages with a latching feature associated with a respective projection of the plurality of projections; and pushing the TPA into the insulative housing with the plurality of terminals inserted.

In yet another aspect, a connector may comprise: an insulative housing comprising a cavity, a mating face and a plurality of openings therethrough, and a terminal position assurance device (TPA) latching feature; a TPA disposed within the cavity and comprising a body and a plurality of terminal receiving spaces, wherein the body comprises a complementary TPA latching feature and each of the plurality of terminal receiving spaces is aligned with an opening through the mating face and comprising a terminal latching feature; a plurality of terminals, each of the plurality of terminals comprising a mating contact portion disposed within a terminal receiving space of the plurality of terminal receiving spaces and comprising a complementary terminal latching feature configured to engage with the terminal latching feature within a receiving space of the plurality of terminal receiving spaces, wherein: for each of the plurality of terminals disposed within a respective terminal receiving space of the plurality of terminal receiving spaces, the terminal latching feature of the respective terminal receiving space and the complementary terminal latching feature are configured to, when engaged, provide a first retention force for retaining the terminal at least in part within the respective terminal receiving space; the TPA latching feature and the complementary TPA latching feature are configured to, when engaged, provide a second retention force for retaining the TPA at least in part within the cavity; and the second retention force is greater than the first retention force.

In yet another aspect, a method of operating an electrical connector comprising a connector housing comprising a mating face and a terminal position assurance device (TPA) configured to latch to the connector housing with a TPA latching feature, the TPA comprising a body with a plurality of terminal receiving spaces configured to receive respective terminals of a plurality of terminals through a first face of the TPA, may comprise: sliding the TPA within the connector housing to engage the TPA latching feature; and with the TPA latching feature engaged, withdrawing at least one terminal of the plurality of terminals through the first face of the TPA.

In yet another aspect, a connector may comprise: an insulative housing which may comprise: a plurality of channels open at a mating interface of the connector; and a plurality of fins; and a plurality of terminals, each of the plurality of terminals comprising: a mating contact portion disposed within a respective channel of the plurality of channels, and a mounting portion extending from the insulative housing and configured for mounting to a printed circuit board at a mounting interface, wherein: the mounting portions of the plurality of terminals are disposed in a line at the mounting interface; and the plurality of fins are configured such that fins of the plurality of fins separate mounting portions of adjacent terminals in the line when the mounting interface is parallel to the mating interface and when the mounting interface is perpendicular to the mating interface.

In yet another aspect, an electrical connector may comprise: a board connector housing, the board connector housing comprising a plurality of channels, wherein: the board connector housing comprises a first side configurable as a mounting interface at the first side and a second side transverse to the first side and configurable as a mounting interface at the second side.

In yet another aspect, a connector may comprise: an insulative housing comprising a plurality of pillars, each of the plurality of pillars comprising a channel extending in a mating direction and comprising an opening at a mating interface of the connector; a terminal position assurance device (TPA) comprising a body and a plurality of projections extending from the body, each of the plurality of projections extending into the channel of a respective pillar of the plurality of pillars; and a plurality of terminals, each of the plurality of terminals disposed at least in part within the channel of a respective pillar of the plurality of pillars and engaged with a respective projection of the plurality of projections; wherein: the TPA is configured to slide in a direction opposite the mating direction into the insulative housing; and a creepage distance at the mating interface of the connector for a predetermined pitch of terminals at the mating interface is dependent on a length of each of the plurality of pillars.

In yet another aspect, a connector configured for mounting on a first side of a printed circuit board with a second side opposite the first side and a connector footprint comprising conductive structures, for electrically coupling to terminals of the connector, exposed at the first side and the second side of the printed circuit board, may comprise: an insulative housing, comprising: a plurality of channels open at a mating interface of the connector; and a plurality of fins comprising: first portions extending from the insulative housing in a first direction to first distal ends; and second portions extending from the insulative housing in a second direction, perpendicular to the first direction, to second distal ends; and a plurality of terminals, each of the plurality of terminals comprising: a mating contact portion disposed within a respective channel of the plurality of channels, wherein the respective channel comprises a wall having a length in the direction perpendicular to the mating interface of a first distance, and a mounting portion extending from the insulative housing and configured for mounting to the printed circuit board at a mounting interface, wherein: the mounting portions of the plurality of terminals are disposed in a line at the mounting interface; the plurality of fins are configured such that: the first portions of the plurality of fins separate mounting portions of adjacent terminals in the line on the first side; the mounting portions of the plurality of terminals are offset from the first distal ends of the fins by a second distance; the second portions of the plurality of fins separate adjacent conductive structures of the connector footprint on the second side; and the conductive structures of the connector footprint on the second side are offset from the second distal ends of the fins by a third distance; and a creepage distance of the connector is determined by the smaller of the first distance, the second distance, and the third distance.

### BRIEF DESCRIPTION OF DRAWINGS

The accompanying drawings are not limited to the dimensions shown. For purposes of clarity, not every component may be labeled in every drawing. In the drawings:

FIG. 1 is a perspective view of an illustrative interconnection system with a mated cable connector and board connector, in accordance with some embodiments.

FIG. 2 is a perspective view of the illustrative connector of FIG. 1 mounted to a printed circuit board at a first mounting interface of the board connector.

FIG. 3A is a front perspective view of the illustrative cable connector of FIG. 1.

FIG. 3B is a rear perspective view of the housing of the illustrative cable connector of FIG. 1.

FIG. 4 is an exploded view of the illustrative interconnection system of FIG. 1.

FIGS. 5A and 5B are cross-sectional views of alternative implementations of the illustrative interconnection system of FIG. 1 with terminals with different tail configurations in the board connector of the interconnection system.

FIGS. 6A-6D are views of the alternative implementations of FIGS. 5A and 5B with creepage paths at the mating interface, at the mounting interface of the board connector, at a side of the cable connector opposite the mating interface, on a surface on one side of a printed circuit board, and on an opposite side of the printed circuit board.

FIGS. 7A-7F are perspective views of steps during assembly of the cable connector of FIG. 3A.

FIGS. 8A-8C are cross-sectional views through three locations of the cable connector of FIG. 3A, with a TPA in an open position.

FIGS. 9A-9C are cross-sectional views through the three positions of FIGS. 8A-8C, with the TPA in a locked position.

FIG. 10A is a perspective, sectional view of the cable connector of FIG. 3A, with the TPA latched in the locked position.

FIG. 10B is a perspective, sectional view of the cable connector of FIG. 3A, with the TPA latched in the open position.

FIG. 11A is a perspective, cross-sectional view of the board connector of FIG. 2 mounted to a printed circuit board (PCB) in a right-angle configuration.

FIG. 11B is a side, cross-sectional view of the board connector housing of FIG. 11A.

FIG. 12A is a perspective view of the board connector of FIG. 2 positioned for mounting to a PCB in a right-angle configuration.

FIG. 12B is a perspective view of the board connector of FIG. 2 positioned for mounting to a PCB in a vertical configuration.

FIG. 13 is a perspective view of the connector of FIG. 1 with a vertical mounting configuration.

### DETAILED DESCRIPTION

The inventors have recognized and appreciated techniques for economically making a connector that is suitable for high voltages in a harsh environment. These techniques may be used separately or one or more of these techniques may be used together.

Techniques as described herein may enable large creepage distances to support high voltage operation, even with a TPA that retains terminals within a cable connector housing in a harsh environment. The TPA may be constructed to engage with a connector housing such that terminals may be easily installed and/or removed, simplifying both initial assembly and repair. The TPA and housing, for example, may have a latching feature and complementary latching feature that cooperate to retain the TPA in the housing such that more force is required to remove the TPA from the housing than to remove the terminals from the TPA.

Moreover, a board connector may be manufactured with a housing that supports mounting to a Printed Circuit Board (PCB) in any of a plurality of orientations, such as in a right angle or a vertical configuration. The housing may be configured to enable a large creepage distance regardless of orientation when mounted. A housing that enables multiple mounting orientations may reduce the number of distinct components that a connector manufacturer needs to produce, improving the economics for those connector configurations that are produced.

Furthermore, the creepage distances of these connectors may be defined by structures that may be easily manufactured in shorter or longer lengths, such that a connector constructed with techniques as described herein can be configured for a desired creepage distance without changing the pitch between terminals in the connector. Such a capability, for example, may enable an automotive designer to change the specification of a connector for greater creepage distance, such as to support operation in a dirtier environment or at a higher voltage, without changing other aspects of cable assembly terminated with such a connector or PCB to which the connector is mounted.

The inventors recognized and appreciated that conventional approaches for providing robustness in a connector may yield connectors that are ill suited for operation at high voltages. Conventional TPAs, for example, may be inserted through an opening in a side of the connector. Such an opening can create a short creepage path between terminals, which can lead to a short creepage distance for the connector. Designs as disclosed herein may incorporate a TPA, with few or no such openings that could shorten creepage paths within the connector.

A connector as described herein may be assembled from a housing subassembly with a TPA latched to a connector housing. The TPA may include terminal receiving spaces and terminal latching features for retaining the terminals in the terminal receiving space. The TPA may be slidable within the connector housing such that the TPA may be pushed into the connector housing to a location where portions of the housing interfere with movement of the latching features and/or complementary latching features such that the terminals are locked within the TPA, which in turn may be latched in place within the housing.

The TPA may be configured such that the terminals are inserted and/or removed through an insertion face opposite the mating face of the connector. Further, the TPA may slide into and/or out of the locked position along a direction perpendicular to the mating face of the connector, such that holes in the sides of the connector housing subassembly for operation of the TPA are not required. Such a configuration results in creepage distances that are long in comparison to conventional connectors in which openings are required in sides of the connector housing for insertion or removal of a TPA. The creepage distances, for example, may be based, at least in part, on the offsets of the terminals from the mating face and/or the insertion face of the TPA through which the terminals are inserted.

Offsets between the mating interface and the point at which the terminals extend from the housing, which impacts the length of a creepage path at the mating interface, may be made relatively large by positioning the terminals within pillars in one connector and within channels of the mating connector. Moreover, the length of these offsets at that mating face may be changed by lengthening or shortening the pillars and/or channels, without changing the pitch between terminals or other aspects of the connection system. The length of the offsets at the insertion face of the cable connector similarly may be changed by changing the length of terminal receiving passages within the TPA.

At the mounting interface of a board connector, creepage distance may be established based at least in part on the length of fins extending from the housing. Such fins may extend in a plane perpendicular to the mounting face of the connector. A fin may separate mounting portions of adjacent terminals extending from the connector housing, such that a creepage path at the mounting face traverses the distal end of the fin. Optionally, fins may extend in two directions such that a portion of the fin separates mounting portions of terminals of the connector on a first side of a PCB, which may be the side to which the connector is mounted. A second portion of the fins may extend in a direction perpendicular to the first portions of the fins to separate conductive structures associated with mounting the connector that extend to the second side of the PCB. These creepage distances may be readily adjusted, without changing terminal pitch, by adjusting the length of the fins in the one or more directions in which they extend.

Optionally, the fins may extend from multiple surfaces of the board connector housing. Such a connector may be mounted to a PCB in any of multiple orientations, enabling housings of a single design to be economically manufactured into connectors configured for use in any of multiple configurations.

These techniques may be used singly or in combination. These techniques are illustrated below in connection with an interconnection system that may be used, for example, to make physical connections between assemblies in an automobile.

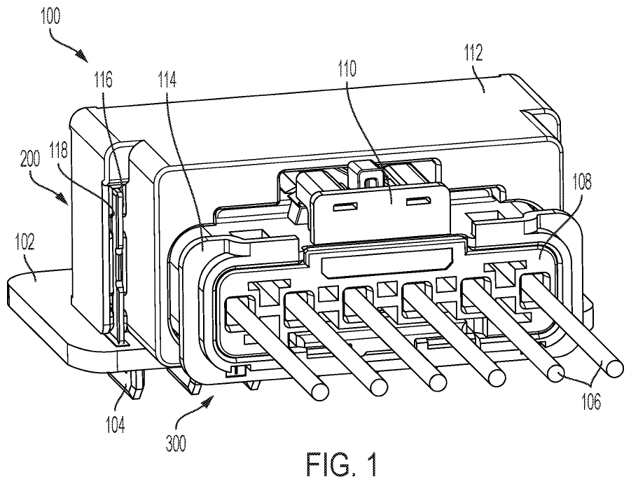

FIG. 1 illustrates an interconnection system 100 with a mated board connector 200 and cable connector 300, in accordance with some embodiments. In the example of FIG. 1, board connector 200 is mounted to a printed circuit board (PCB) 102, only a portion of which is shown in FIG. 1 for simplicity. PCB 102 may be, for example, a PCB in an ECU or other harsh environment. Cable connector 300 is illustrated terminating multiple cables 106. In this example, cable connector 300 terminates six cables 106. In other examples, a cable connector may terminate more or fewer cables. Regardless of the number of cables terminated by cable connector 300, the terminated cables may form a cable assembly, such as a wiring harness in an automobile connecting signals and power to the ECU or other electronic device incorporating board connector 200.

Interconnection system 100 may be configured for use in high voltage applications using one or more of the techniques described herein.

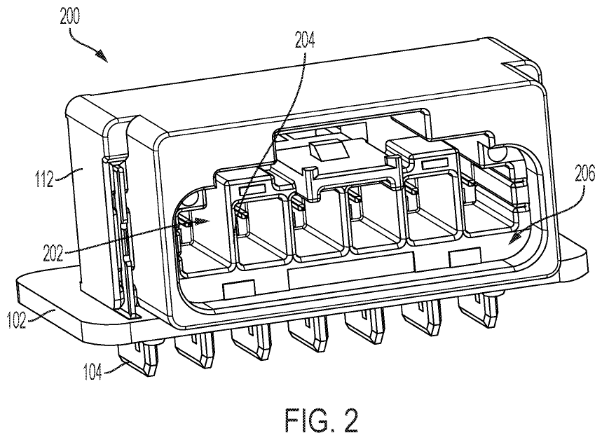

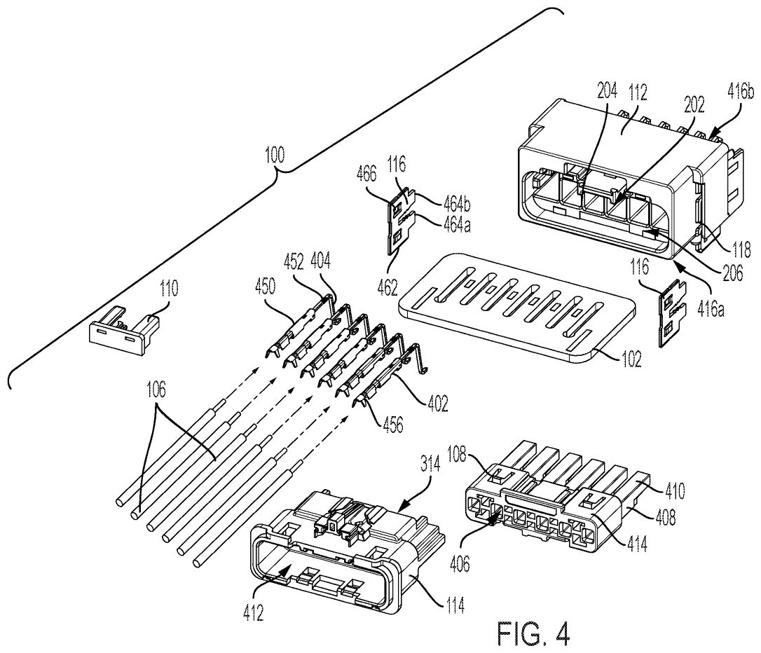

Board connector 200 may comprise an insulative housing 112. In this example, insulative housing 112 is mounted to PCB 102 to provide board connector 200 in a right-angle configuration in which the mating interface (e.g., mating interface 206 of FIG. 2) to cable connector 200 is perpendicular to the mounting interface (e.g., mounting interface 416a of FIG. 4) at which board connector 200 is mounted to PCB 102.

Insulative housing 112 may be mounted to printed circuit board 102 using at least one hold down 116. In the example of FIG. 1, two hold downs 116 are used. Board connector housing 112 may have a hold down slot 118 into which each hold down 116 is inserted and engaged with board connector housing 112. In this example, board connector 200 is configured for surface mount soldering to PCB 102, and a portion of hold down 116 extends from board connector housing 112 in a location that aligns with a pad on a surface of PCB 102 to which hold down 116 may be soldered. In examples in which board connector 200 is configured for mounting to a PCB using other attachment technologies, hold down 116 may have a mounting portion of other shapes. For example, the mounting portion of hold down 116 may be configured as a press fit or as one or more posts for attachment to a PCB using a through hole soldering operation.

Board connector 200 may comprise at least one fin 104. Fins 104 may extend perpendicular to the mounting interface with a fin 104 on each side of a mounting portion of a terminal of board connector 200. Accordingly, in the example of FIG. 1, board connector 200 includes seven (7) fins such that a fin may be positioned on each side of six (6) terminals in board connector 200. Cable connector 300 may comprise an insulative housing 114 into which is inserted terminal position assurance device (TPA) 108. At least one terminal 106 may be inserted in TPA 108. FIG. 1 illustrates a state of the interconnection system in which TPA 108 has been inserted into insulative housing 114 until it is in a locked position. In this state, latching features and complementary latching features on TPA 108 and the terminals (not visible in FIG. 1) engage and are blocked from disengaging by features of insulative housing 114. Accordingly, TPA 108 may assist in retaining terminals 106 within the cable connector housing 114 even in a harsh environment.

Cable connector 300 may include other features, such as a latch and a connector position assurance device (CPA) 110. The latch (not visible in FIG. 1) may hold the cable connector 300 to board connector 200 when engaged with a complementary latching feature on board connector 200. CPA 110 may be configured to ensure the insulative housing 114 is positioned correctly when mated with the board connector housing 112. If cable connector 300 is not properly seated within board connector 200, portions of board connector 200 may block motion of CPA 110 towards board connector 200 such that a large force may be required to slide CPA 110 toward board connector 200, providing feedback to a user that the connectors are not properly mated. Conversely, when board connector 200 and cable connector 300 are properly mated, CPA 110 may slide towards board connector 200 into a state in which CPA 110 blocks the latching feature and complementary latching feature on board connector 200 and cable connector 300 from disengaging.

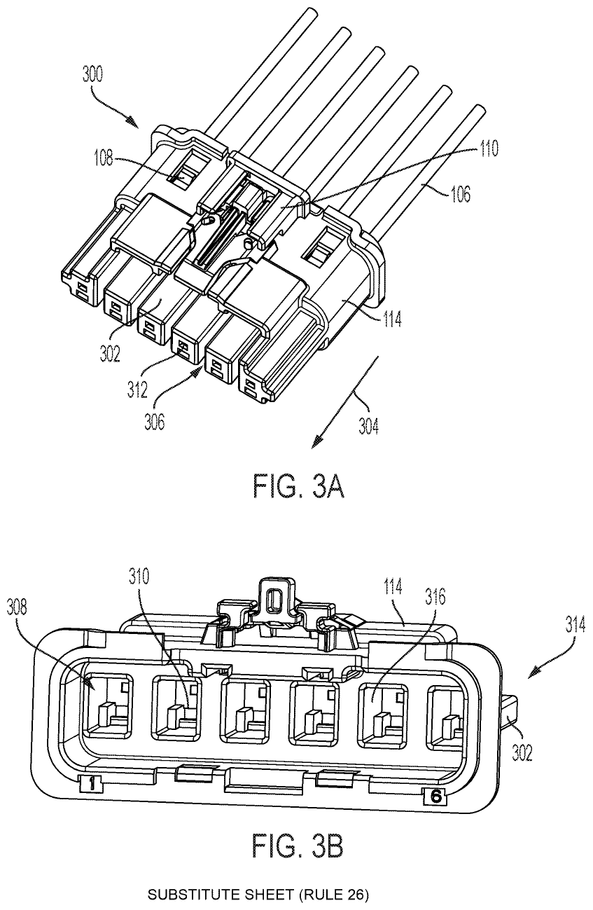

FIG. 2 illustrates the board connector 200 of FIG. 1 mounted to the PCB 102 at the first mounting interface (e.g., mounting interface 416a of FIG. 4) of the board connector 200. In the example of FIG. 2, board connector housing 112 has a plurality of channels 202 open at the mating interface 206 of the board connector 200. Each channel 202 may be configured to receive a pillar of the cable connector (e.g., pillar 302 in FIG. 3A).

The channels 202 may be bounded by walls 204 configured to be on at least one side of a received pillar of the cable connector and bounding channels 202. In the example of FIG. 2, five (5) walls are shown such that for six (6) pillars of the cable connector, a wall 204 is on at least one side.

Each wall 204 may have a length in a direction perpendicular to the mating interface 206 of a same distance. In other examples, the length of each wall 204 may be non-uniform. In the example of FIG. 2, the walls extend between a first and second side of the board connector 200.

FIG. 3A is a perspective view of the cable connector 300 of FIG. 1. In the example of FIG. 3A, the insulative housing 114 has six (6) pillars 302. The insulative housing 114 may have pillars for each terminal 106, and the insulative housing may have a different number of pillars if there is a different number of terminals.

Adjacent pillars 302 may be separated by gaps 306. Each gap 306 may allow for the pillars 302 of cable connector 300 to align with the channels 202 and walls 204 of the board connector 200, each pillar 302 may be inserted into a channel 202, such that the board and cable connectors may mate.

The pillars 302 may extend and have a length parallel to a mating direction 304. TPA 108 may be configured to slide relative to the housing in the mating direction 304 such that TPA 108 is partially inserted into and disposed within the insulative housing 114.

FIG. 3B is a perspective view of the housing 114 of the cable connector 300 of FIG. 1. FIG. 3B is a rear view showing a cavity inside housing 114 into which TPA 108 may be inserted. In this example, the cavity is segmented into channels 308 by the structures that define pillars 302. The pillars 302 of insulative housing 114 may have channels 308 inside them.

Each channel may be bounded on one or more sides by a wall formed as part of the housing 114. In the example of FIG. 3B, each channel 308 is bounded on four sides by walls of the housing. Each channel may be configured to receive a projection of the TPA 108 (i.e., projection 408 of FIG. 4) such as by spacing the projections to align with the channels when the TPA is positioned for insertion into the housing.

The channels 308 may have entrances 310 through which projections (408, FIG. 4) of TPA 108 may be inserted into the channels. The entrances 310 may be open towards a second face of the connector, opposite the mating face 314. With such a configuration, TPA 108 may be fully or partially inserted into housing 114 from that second face via motion in a direction parallel to the mating direction. Insertion in a direction parallel to the mating direction may, for example, avoid the need for openings in the sides of the housing to receive the TPA that could reduce creepage distance. Rather, openings in housing 114 to accommodate TPA 108 are at locations on the connector housing where conductive structures would otherwise be accessible, such as where mating contacts from a mating connector are inserted for mating or where cables 106 connected to the terminals exit the housing 114.

The insulative housing 114 may have side walls 316 between the mating face 314 and the face with holes 310. Side walls 316 may be insulative portions and may be configured to encircle a projection of the TPA 108 and/or encircle a terminal (e.g. 450, FIG. 4). In the illustrated embodiment, terminals are disposed within projections of the TPA such that the side walls 316 encircle both the projections of the TPA and the terminals within them.

The channels 308 may have entrances 312 at a mating face 314 and may extend parallel to the mating direction 304 in FIG. 3A. The entrances 312 at the mating face may enable a mating contact portion of a terminal (e.g. 452, FIG. 4) from a mating connector to enter the channel and mate with a terminal (e.g. 450, FIG. 4) of the cable connector 300 inside housing 114.

FIG. 4 is an exploded view of the interconnection system 100 of FIG. 1. In the illustrated example, cable connector 300 has terminals 450, each of which is configured as a receptacle. Board connector 200 has complementary terminals 452 that mate with terminals 450. In this example, terminals 452 are configured as pins. FIG. 4 illustrates the terminals 450 and 452 in a mated state with the pins inserted into the receptacles, such that the mating portions of each pair of mating terminals are in contact.

In the example of FIG. 4, terminals 452 have tails 404 configured for surface mounting. A plurality of tails 404 are shown in FIG. 4 that terminate in feet that may be used in a surface mount soldering operation during which board connector 200 is soldered to PCB 102. In the example of FIG. 4, board connector 200 is configured as a right-angle connector in which the mating interface of the connector is perpendicular to the mounting interface 416a. Accordingly, terminals 452 have an intermediate portion between the mating contact portions and tails 404 that bend through a right angle.

In the example of FIG. 4, terminals 450 are configured for terminating cables 106. Tails 456 of terminals 450, for example, may be configured for attachment to a cable 106, such as by crimping or soldering. In this example, cable connector 300 is configured for the cables 106 to exit housing 114 through a face of the connector that is parallel to and opposite the mating interface.

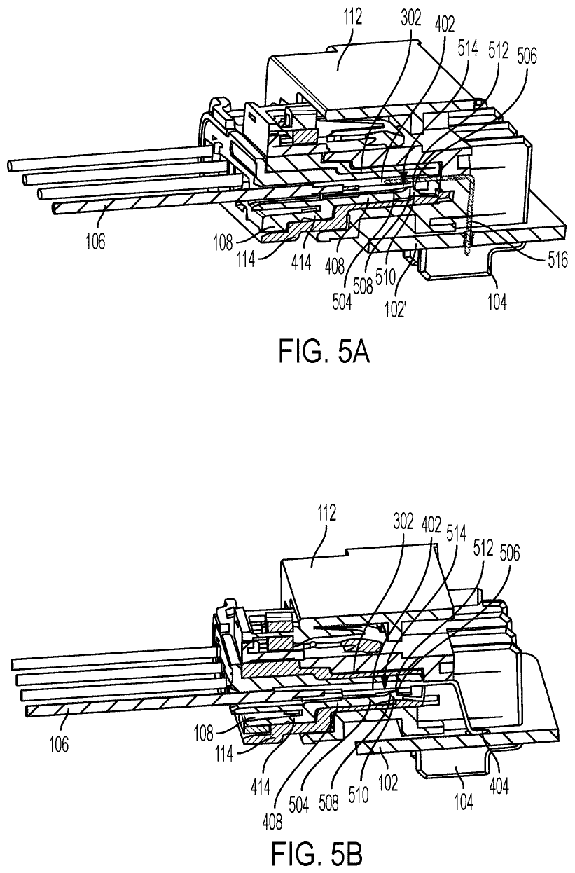

Terminals 450 may additionally include one or more features to aid in positioning and retaining the terminals in a designed location with respect to the housing. For example, a terminal latching feature 402 for each terminal is shown. The terminal latching feature 402 may have a shape and functional complementary to a latching feature of the TPA 108 (e.g., latching feature 506 in FIG. 5A). In this example, the latching feature 506 includes a beam that abuts an edge of a metal sheet formed into the receptacle of the terminal 450. Accordingly, complementary latching feature 402 may be an opening in that sheet into which latching feature 506 may extend to engage and edge of the sheet.

The inventors have recognized and appreciated designs that provide large creepage distances in a board connector and flexible use of a housing that provides flexibility leading to efficient manufacture of connectors for multiple use cases. A large creepage distance in a board connector may be provided by fins that extend from a face of the board connector in multiple directions. The fins, for example, may be generally disposed in parallel planes that are perpendicular to the mating interface of the connector. Each fin may have a portion extending in a direction parallel to the mating direction of the connector and another portion extending perpendicular to the mating direction. One portion of the fins may separate conductive structures, associated with mounting the terminals of the connector to a PCB to which the connector is mounted, on a first side of the PCB. A second portion of the fins may separate conductive structures, associated with mounting the terminals of the connector to the PCB, on a second side, opposite the first side, of the PCB. Each portion of the fins may be sized to provide at least a desired creepage distance in each of multiple connector configurations.

For example, FIG. 4 illustrates a connector housing 112 with terminals 452 configured for a right-angle connector. However, in the illustrated example, housing 112 is also configured to receive vertical mount terminals, configured for a vertical mount connector. Alternatively or additionally, housing 112 may receive terminals that have tails configured as posts for plated through hole soldering to a PCB. In each configuration, the mating contact portions of the terminals in board connector 200 may be the same such that, regardless of the configuration a cable connector with a mating interface as described herein may mate with the board connector.

To support flexibility, in the example of FIG. 4, board connector housing 112 includes faces 416a and 416b, either of which may be configured as a mounting interface by insertion of terminals with tails appropriate for the desired mounting configuration. Accordingly the same board connector housing 112 may be used to make connectors that may be mounted in two different orientations. When the orientation is to be right angle, the mounting interface may be at face 416a. When the orientation is to be vertical, the mounting interface may be formed at face 416b.

Other components of board connector 200 alternatively or additionally may be configured to support flexibility in the use of housing 112. Hold downs 116, for example, are shown with a configuration that also enables mounting in two different orientations.

Hold downs 116 have mounting portions that are exposed at each face that may be used as a mounting interface. In the example of FIG. 4, the hold downs 116 are configured for surface mounting and the mounting portions are surfaces that may be soldered to a pad on a PCB. In this example, hold down surface 462 may be soldered to a PCB in a right-angle connector and surfaces 464a and 464b may be soldered to a PCB in vertical connector.

Hold down 116 also includes a tab 466, which may mechanically couple the hold down 116 to the board connector housing 112. The tab 466 may have an outwardly bent shape. More than one tab 466 may be included. In the example of FIG. 4, hold down 116 includes two tabs 466 which are bent in opposite directions and are configured to engage with opposing sides of hold down slot 118 of the board connector housing 112.

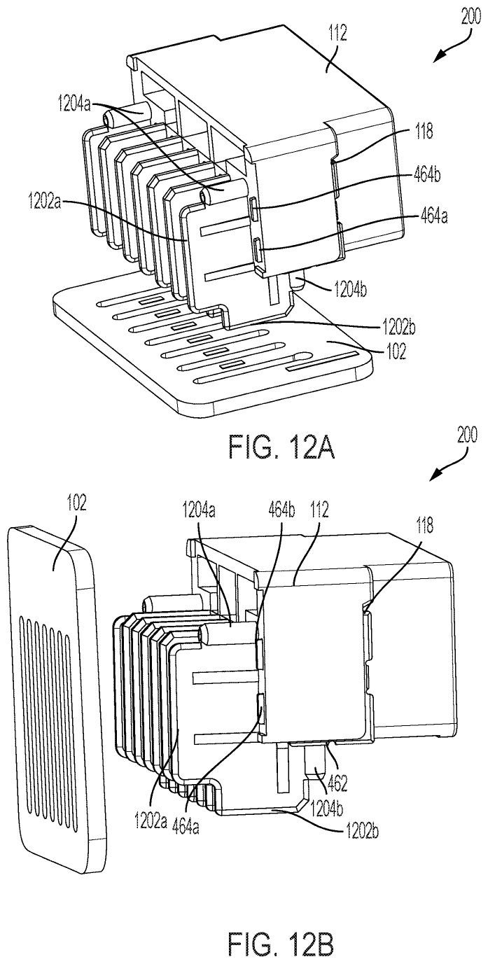

The hold down slots 118 may have open portions at each face that may be potentially used as a mounting interface. In this example, slot 118 has opening in transverse directions to support mounting in different orientations (i.e., vertical and right angle). Accordingly, hold down surface 462 and hold down surfaces 464a and 464b are both exposed. An additional view of hold down slots 118 can be seen in FIGS. 12A and 12B.

In the example of FIG. 4, TPA 108 includes projections 408 with structures, here walls 410, that define terminal receiving spaces. The projections may include a latching component that latches a terminal in the terminal receiving space. TPA 108, for example, may include at least three walls 410 to define a terminal receiving space. TPA 108 may include six projections or any number of projections, such as one projection for each terminal. Once TPA 108 is inserted into housing 114, each projection 408 may be an inner pillar within a pillar 302 of housing 114. The inner pillar may have an inner channel 406 configured to contain a terminal 450 with the walls 410 bounding the terminal 450.

Terminal 450 may be configured to have a mating contact portion disposed within a respective inner channel.

The insulative housing 114 of the cable connector may have a cavity 412, such as an open space, configured to receive the TPA 108. Accordingly, TPA 108 may have a body 414 configured to nest within cavity 412. Each projection 408 may extend from the body 414.

FIGS. 5A and 5B are cross-sectional views of alternative implementations of the interconnection system 100 of FIG. 1 with terminals with different tail configurations in the board connector of the interconnection system. The interconnection system of FIG. 5A includes through hole tails 516 while the interconnection system of FIG. 5B includes surface mount tails 404. Accordingly, FIG. 5B corresponds to the configuration illustrated in FIG. 4. FIG. 5A illustrates the same components, except that terminals 452 have been replaced by terminals with tails 516.

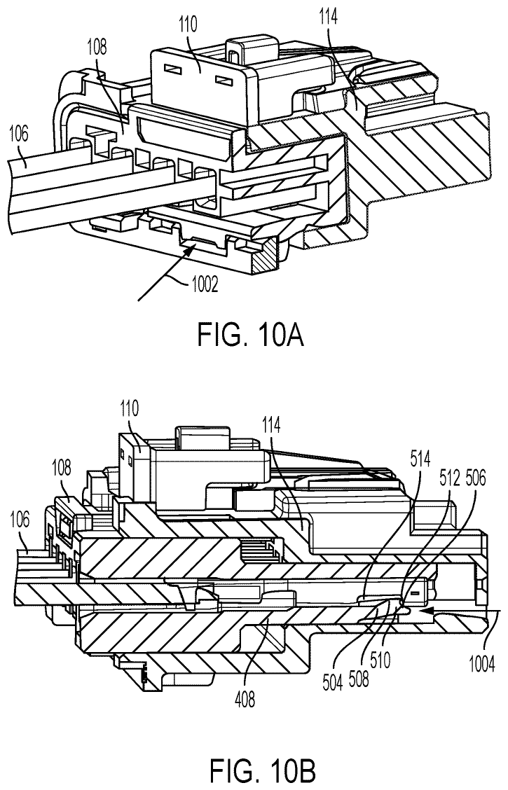

In the sectional views of FIGS. 5A and 5B, a latching feature 506 is visible in each projection 408 (see also FIGS. 10A and 10B for an additional view of latching feature 506). The latching feature 506 may include a compliant beam 504 and a protrusion 508 at a distal end 510 of the compliant beam 504.

Latching feature 506 may be configured to engage with the terminal complementary latching feature 402. The terminal complementary latching feature 402 may include an edge 512 of the sheet forming terminal 450 in contact with the protrusion 508 when in an engaged position. Edge 512 may be an edge adjacent an opening 514.

The complementary latching feature 402 may include the opening 514, which is configured to receive at least a portion of the latching feature 506, such as the protrusion 508 when in an engaged position.

Without wishing to be bound by theory, the latching feature 506 and complementary latching feature 402 enable use of TPA without shortening creepage paths of cable connector 300. Openings in the insulative portions of the connector to support insertion, removal and operation of the TPA are in a channel adjacent a central portion of the terminal such that shorter creepage paths will exist at one and/or the other ends of the terminal. These shorter creepage paths, which are present to enable the conductive structures to enter the consecutive housing of the connector so that the connector operates properly, limit the creepage distance.

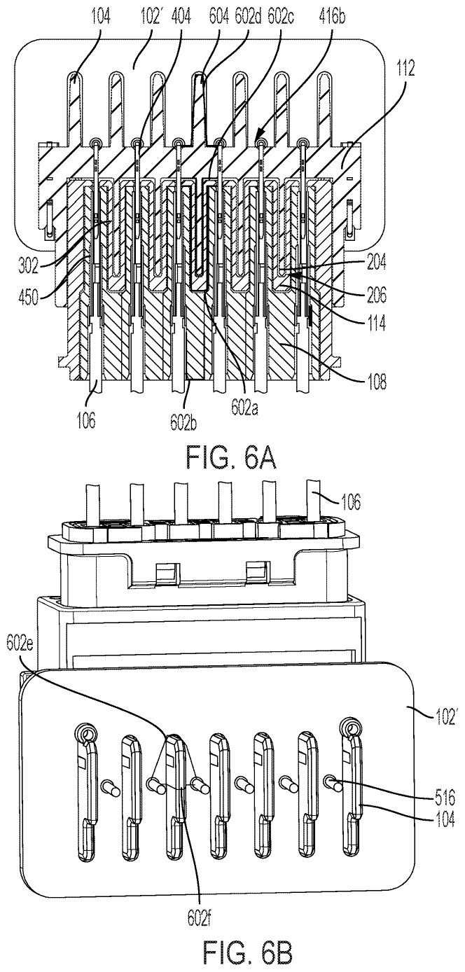

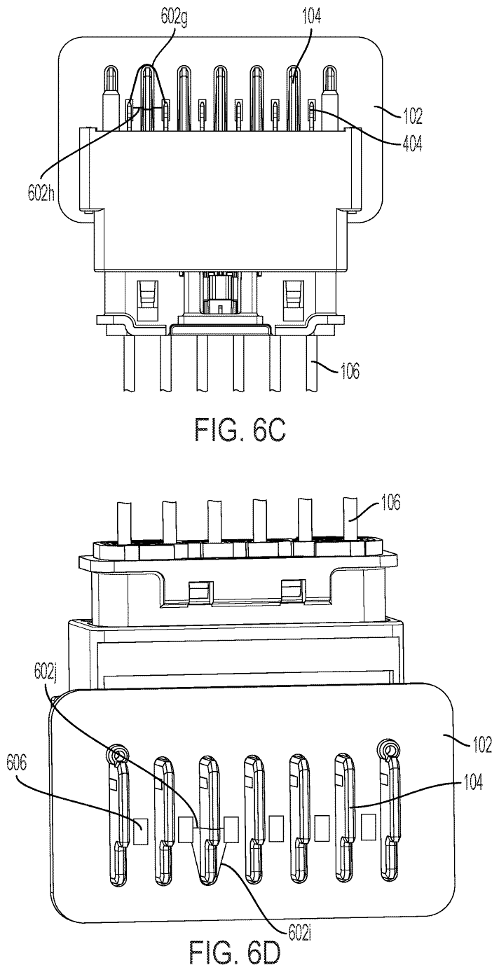

FIGS. 6A-6D are views of right-angle connectors with tail configurations as shown in FIGS. 5A and 5B with creepage paths at several interfaces and locations noted. FIGS. 6A and 6B, for example, illustrates the through hole mounting configuration of FIG. 5A. FIG. 6A is a sectional view through the terminals of the connector looking downwards to a first surface of PCB 102′to which the connector is mounted. FIG. 6B is a view of a second, opposite side, of the PCB illustrating conductive structures associated with mounting of the terminals. Those conductive structures may be, for example, the tails of the terminals (e.g. posts) extending through the PCB, solder connecting the tail to the PCB, and/or a pad around a hole through which the tail extends. Those structures are approximated as tails 516 in FIG. 6B for simplicity, but it should be appreciated that the specific shape of the conductive structures associated with mounting the terminals may vary based on the attachment technology.

In the example of FIG. 6A, four potential creepage paths 602a, 602b, 602c, and 602d are illustrated. Path 602a illustrates a creepage path at the mating interface of the board connector and cable connector. Path 602a in this example traverses surfaces of the cable connector insulative housing 114 between two terminals across which high voltage may exist in operation. The length of path 602a may be at least two times the length of the pillars 302. Accordingly, creepage distance at the mating interface of the cable connector may be dependent on a length of the pillars. In some scenarios, path 602a may be a shortest creepage path in the connector and the creepage distance of the connector may similarly be dependent on a length of the pillars.

Path 602b illustrates a creepage path along surfaces of the TPA 108 between two conductors, terminals 450, across which high voltage may exist in operation. In this example, the length of creepage path 602b may be at least twice the offset between the end of the terminals and the face of the TPA through which the cables 106 extend.

Path 602c illustrates a creepage path at mating interface 206 along surfaces of board connector housing 112 between two terminals across which high voltage may exist in operation. In this example, the length of creepage path 602c may be at least twice the length of the walls 204 separating the terminals within the board connector. Accordingly, creepage distance at the mating interface of the board connector may be dependent on a length of walls 204. In some scenarios, path 602c may be a shortest creepage path in the connector and the creepage distance of the connector may similarly be dependent on a length of the walls 204.

Path 602d illustrates a creepage path at mounting interface 416b traversing the distal end 604 of a fin 104 between two conductors, tails 404, across which high voltage may exist in operation. The length of the path may be dependent on an offset between the conductive structure on the first side of the board for mounting the tails and the distal end of the fins. The path 602d, for example, may be approximately twice the offset. In some scenarios, path 602c may be a shortest creepage path in the connector and a minimum creepage path may traverse at least a portion of a fin 104.

In the example of FIG. 6A, there is no creepage path through a side of wall 316 (e.g., shown in FIG. 3B). Accordingly, a shortest creepage path in the cable connector would traverse the mating face 314 (e.g., shown in FIG. 3B) of the insulative housing or the face opposite the mating face. There is also no creepage path through a wall 204. Accordingly, a shortest creepage path in the board connector would traverse the mating interface 206 or a side opposite the mating interface.

FIG. 6B illustrates two potential creepage paths 602e and 602f in a configuration in which tails 516 are through hole tails. Path 602e is a creepage path on the second surface of PCB 102′between two conductive structures for mounting terminals, approximated as tails 516 in this illustration, across which high voltage may exist in operation. In this example, the creepage path 602e extends around a distal end of fin 104. Creepage path 602e is therefore at least as long as twice the offset (in a direction parallel to the second surface) between that distal end of the fin and conductive structures for mounting adjacent terminals across which high voltage may exist in operation.

An additional creepage path 602f between the same two conductive structures is also illustrated. Path 602f is along the surfaces of the fin 104 traversing a distal end of the fin. In this example, the creepage path 602f extends around a distal end of fin 104. Creepage path 602f is therefore at least as long as twice the offset (in a direction perpendicular to the second surface) between that distal end of the fin and conductive structures for mounting adjacent terminals across which high voltage may exist in operation. The fins 104 may be configured such that paths 602e and 602f are approximately the same length and either may be considered in determining the creepage distance of the connector or connection system. In scenarios where the paths 602e and 602f have different dimensions, the shorter path may be considered in determining creepage distance.

The creepage distance of an interconnection system (or any portion of it such as a connector or an interface of a connector) may be determined by the shortest creepage path within the interconnection system (or portion of the interconnection system). Longer creepage paths may exist but are not illustrated in FIGS. 6A and 6B for simplicity. For example, a path 602f along and over a distal end of a fin is illustrated in FIG. 6B. A corresponding path along and over a fin on the first side of the PCB is not illustrated in FIG. 6A as it is longer than path 602d in this example. However, were such a path shorter than path 602d it could be considered in determining a shortest creepage path and therefore a creepage distance.

Similar considerations apply for connectors of other configurations. FIG. 6C illustrates the first side of the PCB to which a board connector is mounted by surface mount soldering. This figure corresponds to the configuration of FIG. 5B in which tails 404 are surface mount tails. Here, two potential creepage paths 602g and 602 h are illustrated. Path 602g extends along one side of PCB 102, traversing the surface of PCB 102 around fin 104 between two conductive structures associated with mounting two adjacent terminals across which high voltage may exist in operation. In the example, the conductive structures are approximated by the tails 404, which are shaped differently than the tails of FIG. 6A. Nonetheless, path 602g is analogous to path 602 d (FIG. 6A). Path 602 h traverses the surface of fin 104 between two conductive structures associated with mounting two adjacent terminals, across which high voltage may exist in operation.

FIG. 6D illustrates a second side of PCB 102 for which two creepage paths 602i and 602j are illustrated. In this example, the creepage paths are between conductive structures associated with mounting terminals to PCB 102. Though the terminals do not extend through the PCB 102, conductive structures 606 associated with mounting the terminals may extend to the second side. In this example, conductive vias connected to surface mount pads on the first side, for example, may extend to the second side. In this example, the conductive structures are shown schematically as rectangles. The conductive structures 606 may be vias extending through PCB 102, conductive pads on vias, solder, or mounting ends of terminals. The conductive structures 606 may be exposed at both sides of the PCB 102 or may be exposed at one side of the PCB 102. It should be appreciated, however, that the structures may be in other shapes or, in some implementations of an electronic system may not be present. Paths 602i and 602j in this example are analogous to paths 602e and 602f in FIG. 6B differing only in that the shape and position of the conductive structures at the ends of the paths may vary based on difference in the connector footprint of the PCB to which the board connector is mounted. The conductive structures 606, for example, which may electrically couple to terminals.

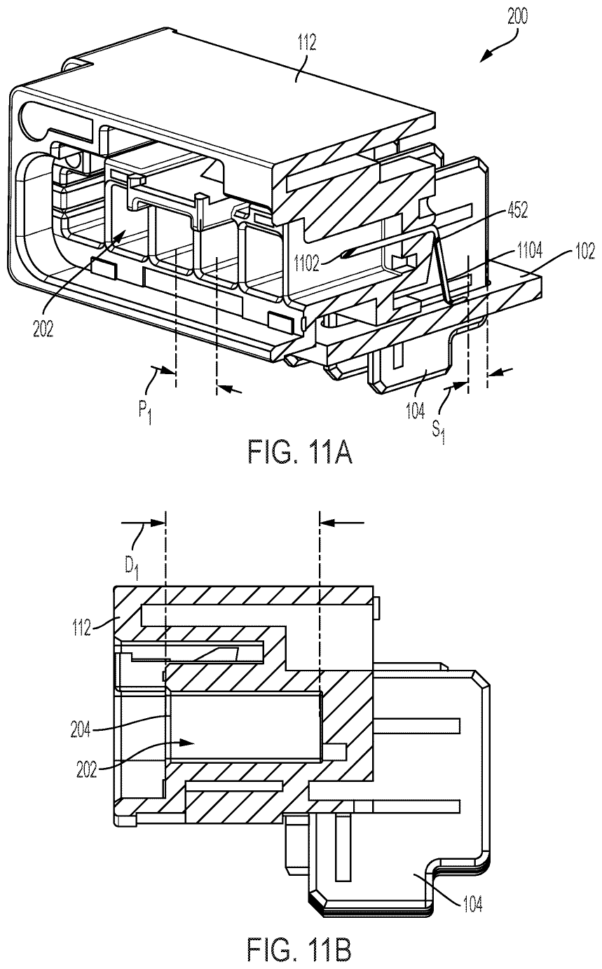

A creepage distance may be determined by the smallest of the paths or relative portions of the paths in FIGS. 6A-6D. The creepage distance of a connector or interconnection system may therefore be set by setting the dimensions of the structures that establish the length of the shortest relevant path. As an example, the creepage distance may be determined by the smallest of a board connector wall housing length (e.g., Di in FIG. 11A), offset (e.g., S1 in FIG. 11A), and another offset along a different axis or surface such as in FIG. 6D from a conductive structure 606 to an end of fin 104.

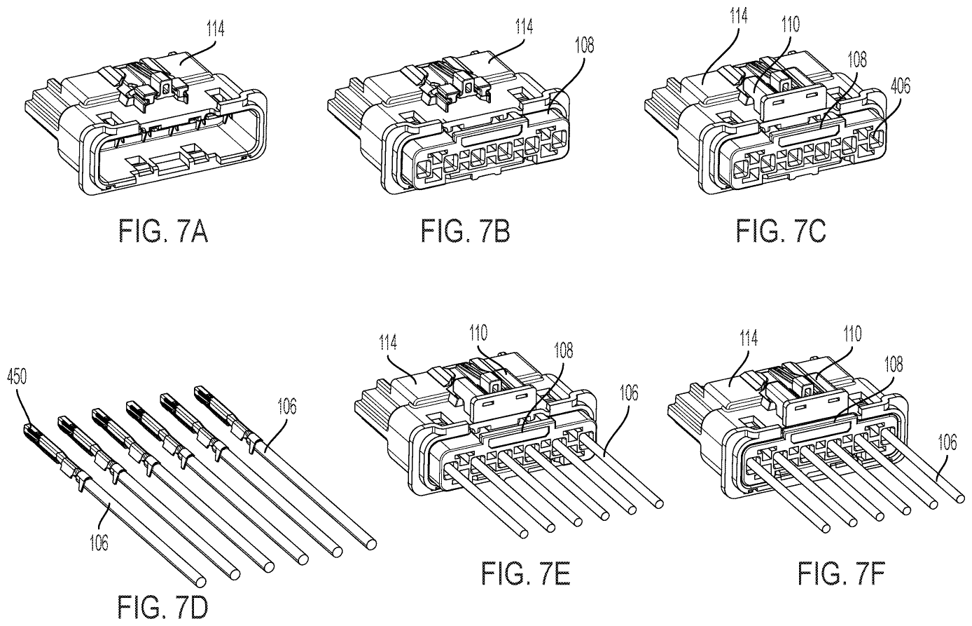

FIGS. 7A-7F illustrate steps of a method of assembling the cable connector of FIG. 3A. The method may be performed by first forming a housing subassembly, and then inserting terminals, terminating cables into the terminal subassembly. The terminals may then be locked in place by operation of a TPA of the housing subassembly. Though FIG. 7A . . . 7F illustrate these steps being performed in sequence, it should be appreciated that it is not necessary for all of the illustrated steps to be performed in the order illustrated or to be performed at the same location or by the same entity. The housing subassembly, for example, may be formed by one entity at one time, whereas terminals may be terminated to cables at a different time or place or by a different entity. Likewise, the final assembly of the connector by inserting and locking the terminals in the housing subassembly may be performed at yet another time or place or by a different entity.

FIG. 7A illustrates assembly of a terminal subassembly beginning with insulative housing 114.

In the example of FIG. 7B, TPA 108 is inserted in insulative housing 114 at least partially, such that TPA 108 is not fully nested within insulative housing 114. TPA 108 may have one or more latching features that engage complementary latching features on the housing 114 to hold the TPA in this first, open position.

In the example of FIG. 7C, CPA 110 is coupled to the insulative housing 114. CPA 110 may likewise be latched to the housing in a first, open position.

In the example of FIG. 7D, terminals 450 have been crimped to cables 106.

As shown in FIG. 7E, terminals 450 terminated to cables 106 may be inserted into corresponding terminal receiving passages of TPA 108. The terminals may be inserted until latching features of the TPA engage complementary latching features of the terminals.

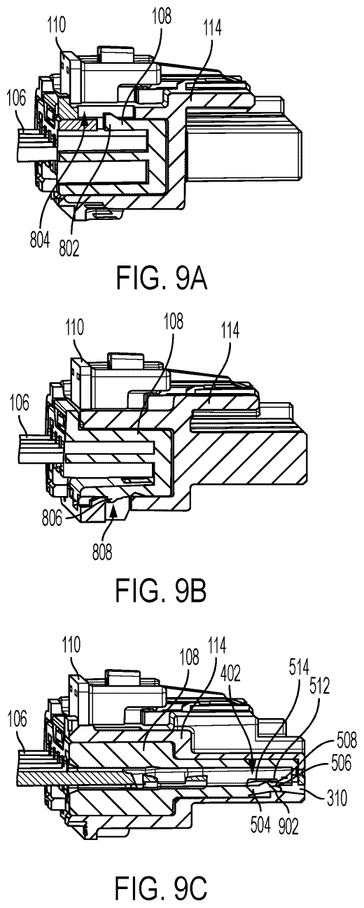

FIG. 7F illustrates that TPA 108 may be pushed so that it slides into insulative housing 114 into a second, locked position. When TPA 108 is pushed into insulative housing 114 with terminals 450, a respective portion (e.g., surface 902 in FIG. 9C) of the insulative housing 114 contacts a respective projection of the TPA at an end portion that contacts the complementary latching feature. This contact blocks the latching feature and/or complementary latching feature from moving so as to disengage, ensuring that the terminals are securely locked in the connector housing.

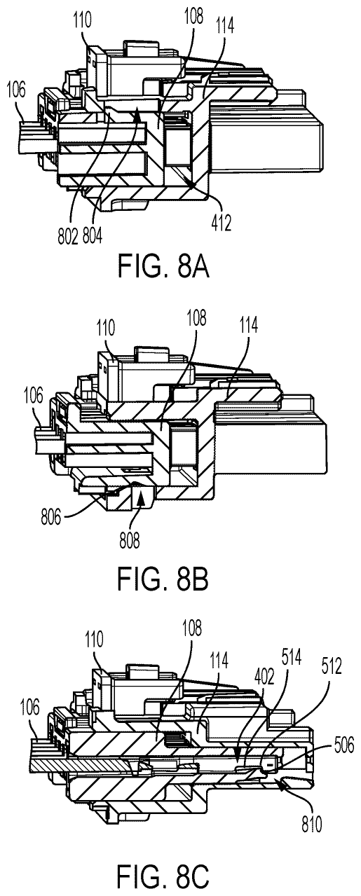

FIGS. 8A-8C are cross-sectional views through three locations of the cable connector 300 of FIG. 3A, with the TPA 108 in a first, open position.

As shown in FIG. 8A, in this state the TPA 108 is partially within the insulative housing 114. The example of FIG. 8A may be the result of performing the step of FIG. 7E.

In this state, TPA 108 may be slidable within housing 114, but the housing and/or TPA may be configured to prevent TPA from being withdrawn from the housing 114. In this example, a latching feature 802 of the TPA is disposed within a hole 804 of housing 114 that is configured to receive the latching feature 802. Latching feature 802, for example may include a compliant beam such that it may deflect to enable TPA 108 to be inserted into the illustrated state. In FIG. 8A, the latching feature 802 is engaged. When the latching feature 802 is within the hole 804 and a force is exerted on the TPA 108 in a direction away from the insulative housing 114, a surface of the insulative housing within the hole 804 acts as a TPA latching feature and contacts the latching feature 802, preventing removal of the TPA 108. While the latching feature 802 is on the TPA 108 in the example of FIG. 8A, the latching feature 802 may be on the insulative housing 114 and the hole 804 may be in the TPA 108.

The latching function may include blocking motion in one or more directions such that the latching feature 802 is used to block motion of the TPA 108 out of the insulative housing 114. The TPA latching feature and latching feature 802, when engaged, provide a first retention force for retaining the TPA at least in part within the cavity 412. In some implementations, the first retention force may be greater than required to withdraw a terminal 450 from TPA 108 when TPA 108 is in the open position. That force, for example, may be the force pulling on a cable 106 required to deflect beam 504 engaged to the terminal terminating that cable. With the latching feature 802 engaged, at least one terminal may be withdrawn from a face of the TPA 108.

Additional latching features and complementary features may be present to hold TPA 108 in a locked position. In the example of FIG. 8B, latching feature 806 is on a side of the TPA 108 opposite latching feature 802. The insulative housing may have a hole 808 on a side of the insulative housing opposite hole 804. The hole 808 may be configured to receive the latching feature 806 when TPA 108 is pushed into the locked position. The hole 808 may alternatively be in TPA 108 and the latching feature 806 may be on the insulative housing 114. In FIG. 8B, the latching feature 806 is not active. When the latching feature 806 is within the hole 808 and a force is exerted on the TPA 108 in a direction away from the insulative housing 114, a surface of the insulative housing within the hole 808 contacts the latching feature 806 and prevents movement of the TPA 108 (e.g., FIG. 9B) out of the locked position.

In the examples of FIGS. 8A-8C, the TPA is in an open position. The latching feature 506 is engaged with the complementary latching feature 402. Latching feature 506 is disposed within a void 810 in the insulative housing 114. The void 810 may be configured to receive the latching feature 506 and may be an open space or may be separated by dividers (not shown). The latching feature 506 may be free to move into the void. The insulative housing may include passages extending between the void 810 and the mating face adjacent a terminal receiving space.

FIGS. 9A-9C are cross-sectional views through the three positions of FIGS. 8A-8C, with the TPA pushed into in a locked position.

In the example of FIG. 9A, the latching feature 802 is not engaged and is disposed within hole 804 without contacting any surfaces of insulative housing 114 bounding the hole 804. In this example, hole 804 is between a first side and a second side of the insulative housing 114.

In the example of FIG. 9B, the latching feature 806 is engaged such that at least one surface of the latching feature 806 contacts at least one surface of the insulative housing bounding the hole 808.

In the example of FIG. 9C, the latching feature 506 is engaged and locked. Latching feature 506 is engaged with complementary latching feature 402 and a surface 902 of insulative housing 114. This state may have been achieved by pressing terminal 450 into the TPA such that compliant beam 504 is deflected as a surface of the terminal rides over the protrusion 508. As the surface of the terminal clears the protrusion 508, protrusion 508 may enter the opening 514 of the terminal as the compliant beam 504 springs back from a deflected state towards an undeflected state. Protrusion 508 may then engage an edge of the terminal bounding opening 514. When engaged, the TPA latching feature and terminal latching feature may provide a second retention force for retaining the terminal at least in part within a terminal receiving space defined by the TPA 108. As noted above, this retention force may be less than the retention force provided by latching features 802 and 804 holding the TPA within the housing, such that terminals may be removed.

A greater retention force, however, may be provided when the latching feature 506 is locked. In a locked state, a portion of the insulative housing 114, such as surface 902, blocks motion of the latching feature 506 away from the respective terminal 450. The surface 902 blocks motion of the compliant beam 504 into the deflected state. When TPA 108 is in the locked state, the latching feature and/or the complementary latching feature may be adjacent the surface 902 within the channel such that the latching feature and complementary latching feature are blocked from disengaging.

FIG. 10A is a perspective, sectional view of the cable connector of FIG. 3A, with the TPA latched in the locked position.

In the example of FIG. 10A, the TPA 108 can be un-latched by applying a force at the location indicated by arrow 1002. A tool may be used to facilitate un-latching the TPA 108.

FIG. 10B is a perspective, sectional view of the cable connector of FIG. 3A, with the TPA latched in the open position.

In the example of FIG. 10B, the TPA 108 can be un-latched by applying a force at the location indicated by arrow 1004. A tool may be used to facilitate un-latching the TPA 108. Arrow 1004 is at an opposite side of TPA 108 from arrow 1002 in FIG. 10A. As can be seen, housing 114 includes a passageway to void 810 to enable the tool to be inserted and push protrusion 508 out of opening 514.

FIG. 11A is a perspective, cross-sectional view of the board connector 200 of FIG. 2 mounted to the PCB 102 in a right-angle configuration.

In the example of FIG. 11A, dimensions of the board connector 200 are illustrated. Pitch P₁ may be center-to-center pitch, such as pitch between channels 202 of the board connector housing 112. The pitch P₁ may be between 4 and 5 mm, such as 4.5 mm as a non-limiting example.

Offset S₁ may be the separation between an end of the terminal 404 and a distal end of the fin 104. In this example, offset S₁ may be measured in a direction perpendicular to the mounting interface of the board connector 200. Offset Si may be any value in the range of 1 mm to 10 mm, for example.

Terminal 404 may have a mating contact portion 1102 disposed within a respective channel 202. Mating contact portion 1102 may be configured to electrically couple with a terminal, such as terminal 450 of FIG. 4.

Terminal 452 may have a mounting portion 1104 extending from the insulative housing 112. Mounting portion 1104 may be configured for mounting to the PCB 102 for mounting at the mounting interface (e.g., 416a or 416b in FIG. 4) and therefore at either a first or second side of the board connector housing 112. The mounting portions 1104 may be disposed in a line at the mounting interface. The plurality of fins 104 may be configured such that they separate mounting portions 1104 of adjacent terminals 404 when the surface configurable as a mounting interface is parallel to the mating interface and when the mounting interface is perpendicular to the mating interface, as shown in FIG. 11A.

FIG. 11B is a side, cross-sectional view of the board connector housing of FIG. 11A. In the example of FIG. 11B, distance D₁ is the length of a wall 204 of the channel 202. The distance DI may be measured in the direction perpendicular to the mating interface.

As described above, creepage distances are predominately set by dimensions such as D₁ and S₁. Therefore, it is not necessary to change the pitch of the terminals within the connector to increase creepage distance. The dimensions of the board connector housing 112 may be changed including changing the offset S₁ and the distance D₁. While some dimensions may be changed, the pitch P₁ may be unchanged and may be predetermined. By changing dimensions offset S₁ and distance D₁, the creepage distance may be increased or decreased. To change the offset S₁, the fin 104 may change in size. To change the distance D₁, the walls 204 may be changed. Such a capability may be of particular advantage to a designer of an automotive system or other systems that may use such connectors.

For example, a system designer may need to change the creepage distance after a system is designed. For example, it may be determined that the system, desired with an assumption of a first degree of pollution may need to be manufactured to withstand a different pollution degree. The pollution degree may be based on the environment and the amount of extraneous particles, such as dirt, in the environment that may provide a conductive path. As pollution degree impacts creepage distance, a change in pollution degree may require a change in the creepage distance. To enable operation with a larger pollution degree, for example, the creepage distance may be increased. In a connector as described herein, this increased creepage distance may be achieved by increasing dimensions that do not change the pitch of the connector. If the pitch of the connector does not change, a connector with an increased creepage distance may be mounted to a PCB in place of a connector with a smaller creepage distance. Such a substitution of parts avoids the need to redesign the entire assembly containing the PCB to which the connector is mounted, providing a further way in which the designs herein increase efficiency. Clearance may also be accounted for by increasing or decreasing these dimensions.

The same dimensions may also impact clearance distance. A connector using techniques as described herein, for example, may be constructed with dimensions that provide a creepage distance of 5 mm or more and a clearance distance of 8.75 mm on the PCB side of a board connector. Such a design may preclude arcing at the PCB side of the board connector, even when 1000V or a 6000V impulse is applied to the connector under environmental conditions corresponding to a pollution degree 2. The same techniques may be used to provide a creepage distance of 12.5 mm or more or a clearance distance of 12.72 mm or more. Such a design may preclude arcing at the PCB side of the board connector, even when 1000V or a 8000V impulse is applied to the connector under environmental conditions corresponding to a pollution degree 3.

FIG. 12A is a perspective view of the board connector 200 of FIG. 2 positioned for mounting to PCB 102 in a right-angle configuration, and FIG. 12B is a perspective view of the board connector 200 of FIG. 2 positioned for mounting to PCB 102 in a vertical configuration.

In the examples of FIGS. 12A and 12B, fins 104 have a first distal end 1202a and a second distal end 1202b. The insulative housing 112 may have a mating interface and a mounting interface. The mounting interface may be a surface parallel to the mating interface or perpendicular to the mating interface. When mounting in a right-angle configuration, as in FIG. 12A, second distal end 1202b is parallel to the mounting interface. When mounting in a vertical configuration, as in FIG. 12B, first distal end 1202a is parallel to the mounting interface. Accordingly, portions of fins 104 extend from and perpendicular to the surface parallel to the mating interface and portions of fins 104 extend from and perpendicular to the surface perpendicular to the mating interface.

When the board connector 200 is surface mount soldered to a first side of the PCB 102, the first distal ends 1202a are on the first side of the PCB 102.

In the example of FIGS. 12A and 12B, board connector 200 includes a post 1204a and a post 1204b. While two posts 1204a are shown in the example of FIGS. 12A and 12B, any number of posts may be included. When mounting in a right-angle configuration, as in FIG. 12A, post 1204a is parallel to the mounting interface and 1204b is perpendicular to the mounting interface. When mounting in a vertical configuration, as in FIG. 12B, post 1204b is parallel to the mounting interface and 1204a is perpendicular to the mounting interface. The connector footprint may include portions of the posts 1204a and 1204b. When mounted, the posts 1204a or 1204b may extend at least partially through the PCB 102 to a second side opposite the first side to which the board connector may be surface mount soldered. Accordingly, the post may extend from and perpendicular to the surface parallel to the mating interface and another post may extend from and perpendicular to the surface perpendicular to the mating interface.

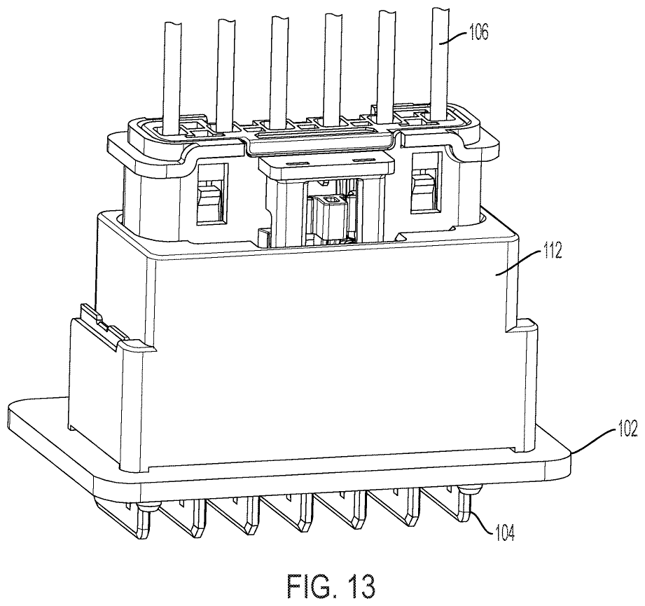

FIG. 13 is a perspective view of the connector of FIG. 1 with a vertical mounting configuration. In the example of FIG. 13, the contact tails may be vertical mount terminals.

Having thus described several aspects of at least one embodiment of this invention, it is to be appreciated that various alterations, modifications, and improvements will readily occur to those skilled in the art.

### EXAMPLE EMBODIMENTS

Concepts as described herein may be embodied as an electrical connector, comprising an insulative housing comprising a plurality of pillars, each pillar of the plurality of pillars comprising a channel extending parallel to a mating direction; a plurality of terminals, each of the plurality of terminals comprising a mating contact portion disposed within a respective channel of a pillar of the plurality of pillars; and a terminal position assurance device (TPA) comprising a body and a plurality of projections extending from the body, each of the plurality of projections extending into the channel of a respective pillar of the plurality of pillars, wherein: each of the plurality of projections comprises a latching feature and each of the plurality of terminals comprises a complementary latching feature configured to engage with the latching feature of a projection of the plurality of projections; and the TPA is configured to slide parallel to the mating direction into the insulative housing such that the latching features of the TPA engage the complementary latching features of the terminals within the channels of the plurality of pillars.

The electrical connector could optionally have one or more of the following: The insulative housing may comprise a plurality of gaps between adjacent pillars of the plurality of pillars. The latching feature of each of the plurality of projections may comprise a compliant beam comprising a distal end and a protrusion at the distal end. The complementary latching feature of each of the plurality of terminals may comprise an opening configured to receive the protrusion of a latching feature within a pillar of the plurality of pillars. The TPA may be configured to slide into a locked position with respect to the insulative housing in which, for each projection of the plurality of projections and a respective terminal within the same channel of the plurality of channels as the projection, a portion of the insulative housing blocks motion of the latching feature away from the respective terminal. Each projection of the plurality of projections may comprise an inner pillar with an inner channel containing a terminal of the plurality of terminals. Each projection of the plurality of projections may comprise at least three walls bounding a terminal of the plurality of terminals. The TPA may be disposed within the insulative housing such that a respective portion of the insulative housing contacts a respective projection at an end portion and the end portion contacts the complementary latching feature of the terminal. At least one opening of the insulative housing may be blocked when the TPA slides into the insulative housing. Each of the plurality of pillars may have a length in the mating direction; and a creepage distance is at least two times the length of the pillars. The insulative housing may have a mating face with entrances to the channels of the plurality of pillars positioned at the mating face; the insulative housing may have a second face, opposite the mating face, the second face comprising an opening configured to receive the TPA; and the insulative housing may comprise side walls between the mating face and the second face that encircle the plurality of terminals, and there may be no creepage path through a side wall to a terminal of the plurality of terminals that does not traverse a portion of the mating face or the second face.

The electrical connector may be mated with a board connector comprising a board connector housing, wherein: the board connector housing comprises a mounting interface and a plurality of channels open at a mating interface of the board connector and bounded by board connector housing walls; the plurality of pillars of the insulative housing may be disposed at least partially within respective channels of the board connector housing; and a minimum creepage path of the board connector may traverse a portion of the mounting interface. The board connector housing may comprise a plurality of fins extending at the mounting interface to a distal end such that the minimum creepage path of the board connector traverses a portion of a fin, including the distal end.

In another aspect, a connector may comprise: an insulative housing comprising a plurality of pillars, each of the plurality of pillars comprising a channel extending in a mating direction; and a terminal position assurance device (TPA) comprising a body and a plurality of projections extending from the body, each of the plurality of projections aligned with the channel of a respective pillar of the plurality of pillars and comprising a latching feature, wherein the TPA is configured to slide in a direction opposite the mating direction into the insulative housing.

The connector could optionally have one or more of the following: The insulative housing may comprise a plurality of gaps between adjacent pillars of the plurality of pillars. The latching feature of each of the plurality of projections may comprise a compliant beam comprising a distal end and a protrusion at the distal end. The TPA may be configured to slide into a locked position with respect to the insulative housing in which, for each projection of the plurality of projections and a respective terminal within the same channel of the plurality of channels as the projection, a portion of the insulative housing blocks motion of the latching feature away from the respective terminal. Each projection of the plurality of projections may comprise an inner pillar with an inner channel. Each projection of the plurality of projections may comprise at least three walls configured to bound a terminal inserted in the projection.

In yet another aspect, a method of assembling an electrical connector comprising an insulative housing with a plurality of channels and a terminal position assurance device (TPA) comprising a plurality of projections with a latching feature associated with each of the plurality of projections, the method comprising: with the TPA partially inserted into the insulative housing of the electrical connector with each of the plurality of projections aligned with a respective channel of the insulative housing of the electrical connector, inserting a plurality of terminals comprising complementary latching features into the TPA such that the complementary latching feature of each of the plurality of terminals engages with a latching feature associated with a respective projection of the plurality of projections; and pushing the TPA into the insulative housing with the plurality of terminals inserted.

The method could optionally include one or more of the following: The latching feature of each of the plurality of projections may comprise a compliant beam with a protrusion at the distal end; the complementary latching feature of each of the plurality of terminals may comprise an edge adjacent an opening in the terminal; and inserting the plurality of terminals into the TPA such that the complementary latching feature of each of the plurality of terminals engages with a latching feature associated with a respective projection of the plurality of projections, may comprise, for each of the plurality of terminals: deflecting the compliant beam as the surface of the terminal rides over the protrusion; and enabling the protrusion to enter the opening of the terminal when the compliant beam springs back from a deflected state towards an undeflected state. For each of the plurality of terminals, the surface within the respective channel may block motion of the compliant beam into the deflected state. Subsequent to the pushing of the TPA, the surface within the respective channel may block motion of the latching feature away from the respective terminal. When the TPA is pushed into the insulative housing, a respective portion of the insulative housing may contact a respective projection at an end portion, said end portion contacting the complementary latching feature of the terminal. The insulative housing may have a mating face with entrances to the channels of the plurality of pillars positioned at the mating face; the insulative housing may have a second face, opposite the mating face, the second face comprising an opening configured to receive the TPA; and the TPA may comprise in combination with the insulative housing insulative portions that encircle the plurality of terminals between the mating face and the second face. The insulative housing may have a mating face with entrances to the channels of the plurality of pillars positioned at the mating face; the insulative housing may have a second face, opposite the mating face, the second face comprising an opening configured to receive the TPA; and a minimum creepage path of the electrical connector may traverse a portion of the mating face or a portion of the second face.

In yet another aspect, a connector may comprise: an insulative housing comprising a cavity, a mating face and a plurality of openings therethrough, and a terminal position assurance device (TPA) latching feature; a TPA disposed within the cavity and comprising a body and a plurality of terminal receiving spaces, wherein the body comprises a complementary TPA latching feature and each of the plurality of terminal receiving spaces is aligned with an opening through the mating face and comprising a terminal latching feature; a plurality of terminals, each of the plurality of terminals comprising a mating contact portion disposed within a terminal receiving space of the plurality of terminal receiving spaces and comprising a complementary terminal latching feature configured to engage with the terminal latching feature within a receiving space of the plurality of terminal receiving spaces, wherein: for each of the plurality of terminals disposed within a respective terminal receiving space of the plurality of terminal receiving spaces, the terminal latching feature of the respective terminal receiving space and the complementary terminal latching feature are configured to, when engaged, provide a first retention force for retaining the terminal at least in part within the respective terminal receiving space; the TPA latching feature and the complementary TPA latching feature are configured to, when engaged, provide a second retention force for retaining the TPA at least in part within the cavity; and the second retention force is greater than the first retention force.

The connector could optionally have one or more of the following: The terminal latching feature and the complementary terminal latching feature may engage such that a protrusion of the terminal latching feature is disposed in an opening of the respective complementary terminal latching feature. The TPA latching feature and the complementary TPA latching feature may engage such that a protrusion of the complementary TPA latching feature is disposed in an opening of the respective TPA latching feature. The terminal latching feature may comprise a compliant beam comprising a distal end and a protrusion at the distal end. The TPA may be configured to slide into a locked position with respect to the insulative housing such that a portion of the insulative housing blocks motion of the terminal latching feature away from the respective terminal. The insulative housing may comprise a void adjacent the terminal latching features of the plurality of terminal receiving spaces; the TPA may be configured to slide into an open position with respect to the insulative housing such that the terminal latching feature is free to move into the void; the TPA latching feature and the complementary TPA latching feature may be a first TPA latching feature and a first complementary TPA latching feature; the insulative housing and the TPA may further comprise a second TPA latching feature and a second complementary TPA latching feature; and the second TPA latching feature and the second complementary TPA latching feature may be configured to engage when the TPA is in the open position. The insulative housing comprises a plurality of passages extending between the mating face and the void adjacent a terminal receiving space.

In yet another aspect, a method of operating an electrical connector comprising a connector housing comprising a mating face and a terminal position assurance device (TPA) configured to latch to the connector housing with a TPA latching feature, the TPA comprising a body with a plurality of terminal receiving spaces configured to receive respective terminals of a plurality of terminals through a first face of the TPA, may comprise: sliding the TPA within the connector housing to engage the TPA latching feature; and with the TPA latching feature engaged, withdrawing at least one terminal of the plurality of terminals through the first face of the TPA.

The method could optionally include one or more of the following: The method may further comprise disengaging the TPA latching feature; and with the TPA latching feature disengaged, withdrawing the TPA from the connector housing. Engaging the TPA latching feature may comprise inserting a portion of a compliant beam on one of the TPA and the housing into an opening of the other of the TPA and the housing. The TPA latching feature may be a first TPA latching feature; the electrical connector may comprise a second TPA latching feature; the second TPA latching feature may be configured to hold the TPA in a locked position with respect to the connector housing in which a portion of the connector housing blocks motion of a terminal latch of the TPA; and the method may further comprise, prior to the sliding the TPA within the connector housing, disengaging the second TPA latching feature.

In yet another aspect, a connector may comprise: an insulative housing which may comprise: a plurality of channels open at a mating interface of the connector; and a plurality of fins; and a plurality of terminals, each of the plurality of terminals comprising: a mating contact portion disposed within a respective channel of the plurality of channels, and a mounting portion extending from the insulative housing and configured for mounting to a printed circuit board at a mounting interface, wherein: the mounting portions of the plurality of terminals are disposed in a line at the mounting interface; and the plurality of fins are configured such that fins of the plurality of fins separate mounting portions of adjacent terminals in the line when the mounting interface is parallel to the mating interface and when the mounting interface is perpendicular to the mating interface.

The connector could optionally have one or more of the following: The insulative housing may comprise a first surface parallel to the mating interface and a second surface perpendicular to the mating interface; at least first portions of fins of the plurality of fins extend from and perpendicular to the first surface, and at least second portions of fins of the plurality of fins extend from and perpendicular to the second surface. The insulative housing may comprise a first mounting post extending from and perpendicular to the first surface; and the insulative housing may comprise a second mounting post extending from and perpendicular to the second surface. The insulative housing may be configured to receive as the plurality of terminals terminals comprising either surface mount tails or through hole tails. The insulative housing may be configured to receive as the plurality of terminals either right angle terminals or vertical mount terminals.

In yet another aspect, an electrical connector may comprise: a board connector housing, the board connector housing comprising a plurality of channels, wherein: the board connector housing comprises a first side configurable as a mounting interface at the first side and a second side transverse to the first side and configurable as a mounting interface at the second side.

The electrical connector could optionally have one or more of the following: The electrical connector may comprise a plurality of terminals, each of the plurality of terminals comprising: a mating contact portion disposed within a respective channel of the plurality of channels, and a mounting portion extending from the board connector housing and configured for mounting to a printed circuit board at the mounting interface at the first side or the second side. The mounting portions of the plurality of terminals may be disposed in a line at the mounting interface. The plurality of channels may be open at a mating interface of the electrical connector. The board connector housing may comprise a plurality of fins configured such that the plurality of fins separate mounting portions of adjacent terminals in the line when the mounting interface is at the first side and when the mounting interface is at the second side. The insulative housing may be configured to receive as the plurality of terminals comprising either surface mount tails or through hole tails.

In yet another aspect, a connector may comprise: an insulative housing comprising a plurality of pillars, each of the plurality of pillars comprising a channel extending in a mating direction and comprising an opening at a mating interface of the connector; a terminal position assurance device (TPA) comprising a body and a plurality of projections extending from the body, each of the plurality of projections extending into the channel of a respective pillar of the plurality of pillars; and a plurality of terminals, each of the plurality of terminals disposed at least in part within the channel of a respective pillar of the plurality of pillars and engaged with a respective projection of the plurality of projections; wherein: the TPA is configured to slide in a direction opposite the mating direction into the insulative housing; and a creepage distance at the mating interface of the connector for a predetermined pitch of terminals at the mating interface is dependent on a length of each of the plurality of pillars.

The electrical connector could optionally have one or more of the following: The connector may be mated to a board connector. The board connector may comprise a board connector housing, comprising a mounting interface and a plurality of fins extending from the mounting interface with a fin of the plurality of fins separating adjacent terminals of the plurality of terminals. A minimum creepage path for the board connector may traverse at least a portion of a fin of the plurality of fins. Each of the plurality of terminals may comprise a mating contact portion disposed within a channel of a respective pillar of the plurality of pillars. The insulative housing may comprise a plurality of gaps, each of the plurality of gaps disposed between adjacent pillars of the plurality of pillars. Each projection of the plurality of projections may comprise an inner pillar with an inner channel containing a terminal of the plurality of terminals.

In yet another aspect, a connector configured for mounting on a first side of a printed circuit board with a second side opposite the first side and a connector footprint comprising conductive structures, for electrically coupling to terminals of the connector, exposed at the first side and the second side of the printed circuit board, may comprise: an insulative housing, comprising: a plurality of channels open at a mating interface of the connector; and a plurality of fins comprising: first portions extending from the insulative housing in a first direction to first distal ends; and second portions extending from the insulative housing in a second direction, perpendicular to the first direction, to second distal ends; and a plurality of terminals, each of the plurality of terminals comprising: a mating contact portion disposed within a respective channel of the plurality of channels, wherein the respective channel comprises a wall having a length in the direction perpendicular to the mating interface of a first distance, and a mounting portion extending from the insulative housing and configured for mounting to the printed circuit board at a mounting interface, wherein: the mounting portions of the plurality of terminals are disposed in a line at the mounting interface; the plurality of fins are configured such that: the first portions of the plurality of fins separate mounting portions of adjacent terminals in the line on the first side; the mounting portions of the plurality of terminals are offset from the first distal ends of the fins by a second distance; the second portions of the plurality of fins separate adjacent conductive structures of the connector footprint on the second side; and the conductive structures of the connector footprint on the second side are offset from the second distal ends of the fins by a third distance; and a creepage distance of the connector is determined by the smaller of the first distance, the second distance, and the third distance.

The connector could optionally have one or more of the following: The walls may be between a third side and a fourth side; and there may be no creepage path through a wall to a terminal of the plurality of terminals that does not traverse the third side or the fourth side. The connector may be configured for surface mount soldering to a first side of a printed circuit board; and the fins may be configured such that the first distal ends of the fins are on the first side of the printed circuit board when the connector is surface mount soldered to the first side of the printed circuit board. The mounting portion of each of the plurality of terminals may comprise a post; and the conductive structures of the connector footprint on the second side of the board may comprise portions of the posts of the plurality of terminals extending through the second side of the printed circuit board. The first direction may be perpendicular to the mating interface.

Techniques described herein may be used in connectors having configurations other than those described above. For example, techniques described herein may be used in mezzanine connectors or in backplane connectors. Such alternative connector configurations may be used with all of the features described herein or a subset of any suitable number of features. Moreover, it should be appreciated that all of the structures, materials and construction techniques described herein may be used together, but, in some embodiments, some or all of the structures, materials or techniques may be omitted.

Such alterations or modifications are intended to be part of this disclosure and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. An electrical connector, comprising:
an insulative housing comprising a plurality of pillars, each pillar of the plurality of pillars comprising a channel extending parallel to a mating direction;
a plurality of terminals, each of the plurality of terminals comprising a mating contact portion disposed within a respective channel of a pillar of the plurality of pillars; and
a terminal position assurance device (TPA) comprising a body and a plurality of projections extending from the body, each of the plurality of projections extending into the channel of a respective pillar of the plurality of pillars,
wherein:
each of the plurality of projections comprises a latching feature and each of the plurality of terminals comprises a complementary latching feature configured to engage with the latching feature of a projection of the plurality of projections; and
the TPA is configured to slide parallel to the mating direction into the insulative housing such that the latching features of the TPA engage the complementary latching features of the terminals within the channels of the plurality of pillars.

2. The electrical connector of claim 1, wherein the insulative housing comprises a plurality of gaps between adjacent pillars of the plurality of pillars.

3. The electrical connector of claim 1, wherein the latching feature of each of the plurality of projections comprises a compliant beam comprising a distal end and a protrusion at the distal end, and wherein the complementary latching feature of each of the plurality of terminals comprises an opening configured to receive the protrusion of a latching feature within a pillar of the plurality of pillars.

4-5. (canceled)

6. The electrical connector of claim 1, wherein:
each projection of the plurality of projections comprises an inner pillar with an inner channel containing a terminal of the plurality of terminals; and
each projection of the plurality of projections comprises at least three walls bounding a terminal of the plurality of terminals.

7. (canceled)

8. The electrical connector of claim 1, wherein:
the TPA is configured to slide into a locked position with respect to the insulative housing in which, for each projection of the plurality of projections and a respective terminal within the same channel of the plurality of channels as the projection, a portion of the insulative housing blocks motion of the latching feature away from the respective terminal, and the TPA is disposed within the insulative housing such that a respective portion of the insulative housing contacts a respective projection at an end portion and the end portion contacts the complementary latching feature of the terminal.

9. The electrical connector of claim 1, wherein:
at least one opening of the insulative housing is blocked when the TPA slides into the insulative housing.

10. The electrical connector of claim 1, wherein:
each of the plurality of pillars has a length in the mating direction; and
a creepage distance is at least two times the length of the pillars.

11. The electrical connector of claim 1, wherein:
the insulative housing has a mating face with entrances to the channels of the plurality of pillars positioned at the mating face;
the insulative housing has a second face, opposite the mating face, the second face comprising an opening configured to receive the TPA; and
the insulative housing comprises side walls between the mating face and the second face that encircle the plurality of terminals, and there is no creepage path through a side wall to a terminal of the plurality of terminals that does not traverse a portion of the mating face or the second face.

12. The electrical connector of claim 11, mated with a board connector comprising a board connector housing, wherein:
the board connector housing comprises a mounting interface and a plurality of channels open at a mating interface of the board connector and bounded by board connector housing walls;
the plurality of pillars of the insulative housing are disposed at least partially within respective channels of the board connector housing; and
a minimum creepage path of the board connector traverses a portion of the mounting interface.

13. The electrical connector mated to the board connector of claim 12, wherein the board connector housing comprises a plurality of fins extending at the mounting interface to a distal end such that the minimum creepage path of the board connector traverses a portion of a fin, including the distal end.

14. A connector, comprising:
an insulative housing comprising a plurality of pillars, each of the plurality of pillars comprising a channel extending in a mating direction; and
a terminal position assurance device (TPA) comprising a body and a plurality of projections extending from the body, each of the plurality of projections aligned with the channel of a respective pillar of the plurality of pillars and comprising a latching feature,
wherein the TPA is configured to slide in a direction opposite the mating direction into the insulative housing.

15-16. (canceled)

17. The connector of claim 14, wherein the latching feature of each of the plurality of projections comprises a compliant beam comprising a distal end and a protrusion at the distal end, and wherein:
the TPA is configured to slide into a locked position with respect to the insulative housing in which, for each projection of the plurality of projections and a respective terminal within the same channel of the plurality of channels as the projection, a portion of the insulative housing blocks motion of the latching feature away from the respective terminal.

18-19. (canceled)

20. A method of assembling an electrical connector comprising an insulative housing with a plurality of channels and a terminal position assurance device (TPA) comprising a plurality of projections with a latching feature associated with each of the plurality of projections, the method comprising:
with the TPA partially inserted into the insulative housing of the electrical connector with each of the plurality of projections aligned with a respective channel of the insulative housing of the electrical connector, inserting a plurality of terminals comprising complementary latching features into the TPA such that the complementary latching feature of each of the plurality of terminals engages with a latching feature associated with a respective projection of the plurality of projections; and
pushing the TPA into the insulative housing with the plurality of terminals inserted.

21. The method of claim 20, wherein:
pushing the TPA into the insulative housing with the plurality of terminals inserted comprises positioning the TPA within the insulative housing such that the latching feature and/or complementary latching feature is positioned adjacent a surface within the respective channel that blocks the latching feature and complementary latching feature from disengaging.

22. The method of claim 21, wherein:
the latching feature of each of the plurality of projections comprises a compliant beam with a protrusion at a distal end;
the complementary latching feature of each of the plurality of terminals comprises an edge adjacent an opening in the terminal; and
inserting the plurality of terminals into the TPA such that the complementary latching feature of each of the plurality of terminals engages with a latching feature associated with a respective projection of the plurality of projections, comprises, for each of the plurality of terminals:
deflecting the compliant beam as the surface of the terminal rides over the protrusion; and
enabling the protrusion to enter the opening of the terminal when the compliant beam springs back from a deflected state towards an undeflected state.

23. The method of claim 22, wherein for each of the plurality of terminals:
the surface within the respective channel blocks motion of the compliant beam into the deflected state.

24. The method of claim 21 wherein subsequent to the pushing of the TPA, the surface within the respective channel blocks motion of the latching feature away from the respective terminal.

25. The method of claim 20, wherein when the TPA is pushed into the insulative housing, a respective portion of the insulative housing contacts a respective projection at an end portion, said end portion contacting the complementary latching feature of the terminal.

26. The method of claim 20, wherein:
the insulative housing has a mating face with entrances to the channels of a plurality of pillars positioned at the mating face;
the insulative housing has a second face, opposite the mating face, the second face comprising an opening configured to receive the TPA; and
the TPA comprises in combination with the insulative housing insulative portions that encircle the plurality of terminals between the mating face and the second face.

27. The method of claim 20, wherein:
the insulative housing has a mating face with entrances to the channels of a plurality of pillars positioned at the mating face;
the insulative housing has a second face, opposite the mating face, the second face comprising an opening configured to receive the TPA; and
a minimum creepage path of the electrical connector traverses a portion of the mating face or a portion of the second face.

28-60. (canceled)
